(19) United States
(12) Patent Application Publication
(10) Pub. No.: US 2019/0358487 A1
(43) Pub. Date: Nov. 28, 2019

(54) EXERCISE MAT TOPPER

(71) Applicant: Soul Seal LLC, Vail, CO (US)

(72) Inventor: Victoria L. Mason, Vail, CO (US)

(21) Appl. No.: 16/413,258

(22) Filed: May 15, 2019

Related U.S. Application Data
(60) Provisional application No. 62/676,309, filed on May 25, 2018.

(51) Int. Cl. A63B 21/00; B32B 27/12

(52) U.S. Cl. CPC A63B 21/4037; B32B 2255/02; B32B 2250/02; B32B 27/12

(57) ABSTRACT

The present disclosure describes an exercise mat topper comprising a fabric layer, a coating layer and a backing layer. An exercise mat complex is also described.

### RELATED APPLICATION

The present invention claims priority from and the benefit of U.S. Provisional Patent Application No. 62/676,309, filed May 25, 2018, the disclosure of which is hereby incorporated herein in its entirety.

### FIELD OF THE INVENTION

The present invention relates to an exercise mat topper, and more particular, a topper for a yoga mat.

### BACKGROUND OF THE INVENTION

In recent years, the popularity of yoga has quickly expanded. Yoga has been shown and may be recommended to promote relaxation, reduce stress, and improve some medical conditions. Most people who practice yoga use specially fabricated mats. The first commercially produced yoga mats were made from polyvinyl chloride, but more recently, commercial mats have become made from natural jute and rubber. However, using a “communal” rubber mat at the gym may be, or at least, feel unsanitary. In addition, a towel placed over the top of the rubber mat may need to be adjusted constantly during one's yoga session, which can be frustrating for a user. Therefore, there may be a need for a mat topper that creates a sanitary barrier and firmly adheres to the conventional yoga mat.

### SUMMARY OF THE INVENTION

A first aspect of the present invention is directed to an exercise mat topper. The exercise mat topper comprises a fabric layer, a coating layer and a backing layer. The fabric layer may comprise nylon, polypropylene or polyethylene fibers, or any combination thereof. The fabric layer may be treated with a silver ion-based antibacterial agent. The coating layer may comprise an acrylic copolymer. The backing layer may comprise a styrene acrylic binder.

Another aspect of the present invention is directed to an exercise mat complex. The exercise mat complex may comprise an exercise mat formed of a polymeric material and a exercise mat topper having a fabric layer, a coating layer, and a backing layer. The exercise mat topper may be configured to firmly grip to the top of the exercise mat.

It is noted that aspects of the invention described with respect to one embodiment, may be incorporated in a different embodiment although not specifically described relative thereto. That is, all embodiments and/or features of any embodiment can be combined in any way and/or combination. Applicant reserves the right to change any originally filed claim and/or file any new claim accordingly, including the right to be able to amend any originally filed claim to depend from and/or incorporate any feature of any other claim or claims although not originally claimed in that manner. These and other objects and/or aspects of the present invention are explained in detail in the specification set forth below. Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1 is a top view of an exercise mat topper according to embodiments of the present invention.

FIG. 2 is a side view of the exercise mat topper of FIG. 1.

FIG. 3 is a side view of a yoga mat assembly according to further embodiments of the present invention.

### DETAILED DESCRIPTION OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

The present invention now will be described more fully hereinafter with reference to the accompanying drawings, in which illustrative embodiments of the invention are shown.

In the figures, certain layers, components or features may be exaggerated for clarity, and broken lines illustrate optional features or operations unless specified otherwise. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

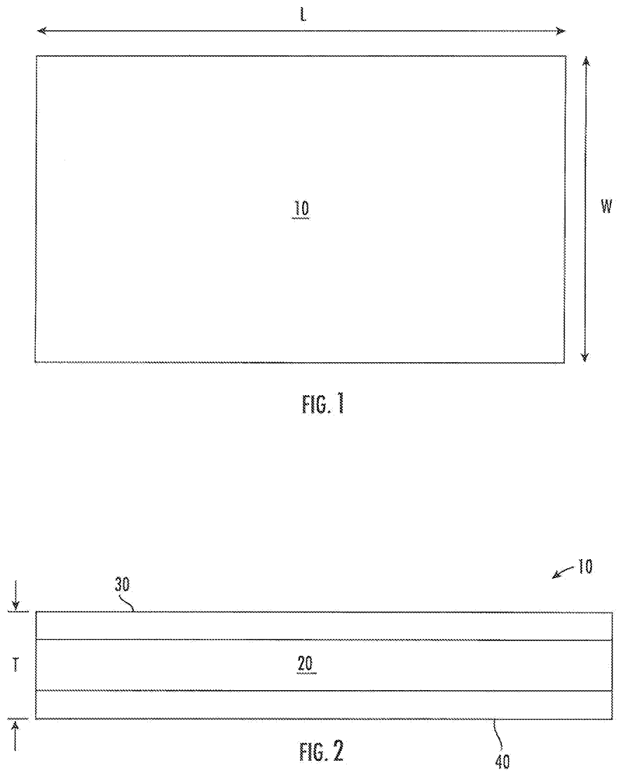

Referring now to the figures, an exercise mat topper 10 according to some embodiments of the present invention is illustrated in FIG. 1. FIG. 1 shows a rectangular exercise mat topper 10 having a length (L) and a width (W). The exercise mat topper 10 is of a sufficient size to cover a standard exercise mat (e.g., yoga mat) and support a user's body through a wide range of exercise positions. In general, the exercise mat topper 10 has a length (L) of about 65 inches to about 80 inches and a width (W) of about 20 inches to about 30 inches. Although the exercise mat topper 10 is shown in FIG. 1 is rectangular in shape, it should be noted that the exercise mat topper 10 may have other shapes, such as, for example, square, circular, elliptical, or oval, or any other shape or design.

In some embodiments, the exercise mat topper 10 may be suitable for use over a rubber exercise mat. In some embodiments, the rubber exercise mat may be a yoga mat. In some embodiments, the exercise mat topper 10 may be suitable for use on various other surfaces, such as, for example, hardwood floors, carpeted floors, or other surfaces, or any combination thereof.

In some embodiments, the exercise mat topper 10 may be constructed such that the exercise mat topper 10 can be machine-washed. In some embodiments, the exercise mat topper 10 may be constructed such that the exercise mat topper 10 can be rolled for easy travel and/or storage. In some embodiments, the exercise mat topper 10 is lightweight. In general, the exercise mat topper 10 has a total weight of about 13 ounces to about 24 ounces.

As shown in FIG. 2, the exercise mat topper 10 may comprise a fabric layer 20. The fabric layer 20 may comprise a woven fabric. In some embodiments, the fabric layer 20 is woven in a plain weave. In some embodiments, fabric layer 20 may comprise a woven fabric made up of filament fibers, staple fibers, or a combination thereof. In some embodiments, the fabric layer 20 comprises about 70% to about 80% filament fibers by weight and about 20% to about 30% staple fibers by weight. The fabric layer 20 may comprise a microfiber, which can be a synthetic or natural material. In some embodiments, the fabric layer 20 may comprise nylon, polypropylene or polyethylene fibers, or any combination thereof. The fabric layer 20 may comprise other fibers and/or compositions. In some embodiments, the woven fabric of the fabric layer 20 may have about 50 picks per inch to about 70 picks per inch. In some embodiments, the woven fabric of the fabric layer 20 may have about 150 ends per inch to about 170 ends per inch. In some embodiments, the woven fabric of the fabric layer 20 may have about 45 threads/cm² to about 65 threads/cm² in the filling direction. In some embodiments, the woven fabric of the fabric layer 20 may have a weight of about 8.0 ounces/yards² to about 15.0 ounces/yards².

The fabric layer 20 can also provide additional cushioning for a user of the exercise mat topper 10. In some embodiments, the exercise mat topper 10 has an overall thickness (T) of about 1 mm to about 3.5 mm.

In some embodiments, the fabric layer 20 may be treated with an antimicrobial agent. In some embodiments, the antimicrobial agent is a silver ion-based antimicrobial. The antimicrobial agent can help resist the growth of odor-causing bacteria on the exercise mat topper 10; thus the exercise mat topper 10 smells clean over an extended amount of time. Exemplary types of antimicrobial agents that may be used to treat the fabric layer 20 include, but are not limited to, antimicrobial agents provided by Crypton® (Kings Mountain, N.C.). See also, e.g., U.S. Patent Application Publication No. 2012/0129418, which is incorporated by reference in its entirety herein.

The exercise mat topper 10 may also comprise a coating layer 30. The coating layer 30 may be applied on top of the fabric layer 20. In some embodiments, the coating layer 30 may comprise an acrylic copolymer. Exemplary types of acrylic copolymers that may be used for the coating layer 30 include, but are not limited to, acrylic copolymers provided by Unichem, Inc. (Haw River, N.C.). The coating layer 30 can provide traction to the exercise mat topper 10 which can help to minimize slippage of a user's hands and/or feet during a workout and/or yoga session.

The exercise mat topper 10 may also comprise a backing layer 40. The backing layer 40 can provide friction and/or traction on the bottom of the exercise mat topper 10, such that, when it is placed in contact with a rubber exercise mat by a user, the exercise mat topper 10 does not slip or slide while the exercise mat topper 10 is being used by the user. In some embodiments, the backing layer 40 may comprise a styrene acrylic binder. In some embodiments, the styrene acrylic binder can impart fiber-to-fiber cohesion of the fabric layer 20. The styrene acrylic binder may also improve abrasion resistance and slip resistance when applied to the bottom of the fabric layer 20.

The antimicrobial agent and/or styrene acrylic binder can be applied to the fabric layer 20 using any suitable application technique. In some embodiments, the coating layer 30 and/or backing layer 40 may be applied via a pad-dry process where the fabric layer 20 is fully immersed in either the antimicrobial agent or styrene acrylic binder and then dried. In some embodiments, the backing layer 40 may also be applied to the fabric layer 20 via knife coating, foam coating or kiss roll coating.

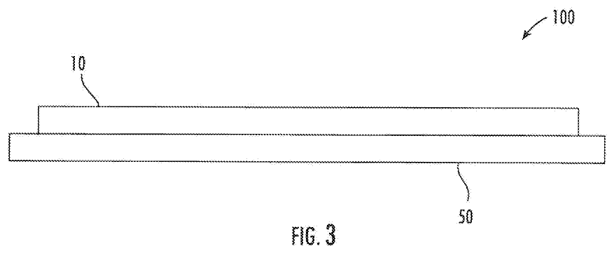

An exercise mat complex 100 according to further embodiments of the present invention is illustrated in FIG. 3. The exercise mat complex 100 may comprise an exercise mat 50. The exercise mat 50 may be formed from a polymeric or elastomeric material. For example, the exercise mat 50 may be formed from rubber. The exercise mat assembly 100 may further comprise an exercise mat topper 10 of the types discussed above. The exercise mat topper 10 may be configured to firmly grip to the exercise mat 50, thereby providing improved slip resistance when placed on top of the exercise mat 50. In some embodiments, the exercise mat 50 may be a yoga mat.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. An exercise mat topper, comprising:
a fabric layer, the fabric layer comprising nylon, polypropylene or polyethylene fibers, or any combination thereof, wherein the fabric layer is treated with a silver ion-based antibacterial agent;
a coating layer comprising an acrylic copolymer; and
a backing layer opposite the coating layer comprising a styrene acrylic binder.

2. The exercise mat topper of claim 1, wherein the exercise mat has a thickness of about 1 mm to about 3.5 mm.

3. The exercise mat topper of claim 1, wherein the fabric layer is woven in a plain weave.

4. The exercise mat topper of claim 1, wherein the fabric layer comprises about 70% to about 80% filament fibers by weight and about 20% to about 30% staple fibers by weight.

5. The exercise mat topper of claim 1, wherein the fabric layer comprises a woven fabric having about 50 picks per inch to about 70 picks per inch and about 150 ends per inch to about 170 ends per inch.

6. The exercise mat topper of claim 1, wherein the fabric layer comprises a woven fabric having about 45 threads/cm² to about 65 threads/cm² in the filling direction.

7. The exercise mat topper of claim 1, wherein the fabric layer has a weight of about 8.0 ounces/yards² to about 15.0 ounces/yards².

8. The exercise mat topper of claim 1, wherein the backing layer is configured to provide traction when placed in contact with a surface of a rubber mat.

9. The exercise mat topper of claim 1, in combination with an exercise mat, wherein the exercise mat topper is configured to firmly grip to the top of the exercise mat.

10. The exercise mat topper of claim 9, wherein the exercise mat is a yoga mat.

11. An exercise mat complex, comprising:
an exercise mat formed of a polymeric material; and
an exercise mat topper having a fabric layer, a coating layer, and a backing layer, wherein the exercise mat topper is configured to firmly grip to the top of the exercise mat.

12. The exercise mat complex of claim 11, wherein the fabric layer comprises nylon, polypropylene or polyethylene fibers, or any combination thereof, and is treated with a silver ion based antibacterial agent, the coating layer comprises an acrylic copolymer, and the backing layer comprises a styrene acrylic binder.

13. The exercise mat complex of claim 11, wherein the exercise mat is a yoga mat.
